(19) United States
(12) Patent Application Publication
(10) Pub. No.: US 2021/0402757 A1
(43) Pub. Date: Dec. 30, 2021

(54) IMAGE PROCESSING APPARATUS, IMAGE FORMING APPARATUS AND COMPUTER READABLE STORAGE MEDIUM

(71) Applicant: KONICA MINOLTA, INC., Tokyo (JP)

(72) Inventor: Tetsu KAWASAKI, Tokyo (JP)

(73) Assignee: KONICA MINOLTA, INC., Tokyo (JP)

(21) Appl. No.: 17/346,490

(22) Filed: Jun. 14, 2021

(30) Foreign Application Priority Data
Jun. 26, 2020 (JP) 2020-110053

(51) Int. Cl. B41J 2/045; B41J 2/125

(52) U.S. Cl. CPC B41J 2/0451; B41J 2002/17573; B41J 2/125

(57) ABSTRACT

An image processing apparatus includes a hardware processor, an obtaining unit, a comparator, an adjuster and a notifying unit. The hardware processor obtains a read image from a reader that reads a print-through image formed on a back surface opposite an image forming surface of a recording medium. A target image is formed on the image forming surface with a color material, and the print-through image is formed on the back surface by the color material permeating through the recording medium. The obtaining unit obtains a comparison image in which the target image is at least recognizable. The comparator compares the read image with the comparison image. Depending on a result of the comparison by the comparator, the hardware processor causes at least one of (i) the adjuster to adjust a printing process parameter and (ii) the notifying unit to perform notification.

### CROSS-REFERENCE TO RELATED APPLICATIONS

The entire disclosure of Japanese Patent Application No. 2020-110053 filed on Jun. 26, 2020 is incorporated herein by reference in its entirety.

### BACKGROUND

### Technological Field

The present disclosure relates to an image processing apparatus, an image forming apparatus and a computer readable storage medium.

### Description of the Related Art

It is known that an inkjet image forming apparatus causes a phenomenon called print-through in which ink applied to an image forming surface of a recording medium at the time of image formation permeates through the recording medium and seeps to the back surface opposite the image forming surface of the recording medium.

As a technique for preventing print-through, for example, there is disclosed in JP 2011-63020 A scanning a surface opposite a printed surface (image forming surface), and in response to detecting print-through of ink, changing a printing process parameter, such as the amount of ink, thereby adjusting the amount of ink, to prevent print-through.

### SUMMARY

However, in practice, there is a case where print-through is desired. That is, there is a case where a user desires that the same image as that formed on a surface is formed on the opposite surface too with his/her desired density. For example, an advertisement flag has a higher advertising effect if an image is seen from the back surface too.

The technique disclosed in JP 2011-63020 A cannot perform image formation so as to form a print-through image, which is the same as an image formed on the image forming surface, with a user's desired density.

Objects of the present disclosure include providing an image processing apparatus, an image forming apparatus and a computer readable storage medium storing a program each of which is capable of performing image formation with a user's desired print-through image density.

In order to achieve at least one of the objects, according to an aspect of the present disclosure, there is provided an image processing apparatus including:

a hardware processor that obtains a read image from a reader that reads a print-through image formed on a back surface opposite an image forming surface of a recording medium, wherein a target image is formed on the image forming surface with a color material, and the print-through image is formed on the back surface by the color material permeating through the recording medium;

an obtaining unit that obtains a comparison image in which the target image is at least recognizable;

a comparator that compares the read image with the comparison image;

an adjuster that adjusts a printing process parameter; and

a notifying unit that performs notification,

wherein depending on a result of the comparison by the comparator, the hardware processor causes at least one of (i) the adjuster to perform the adjustment and (ii) the notifying unit to perform the notification.

In order to achieve at least one of the objects, according to another aspect of the present disclosure, there is provided an image forming apparatus including:

an image forming unit that forms an image on a recording medium; and

the above image processing apparatus.

In order to achieve at least one of the objects, according to another aspect of the present disclosure, there is provided a non-transitory computer readable storage medium storing a program that causes a computer of an image processing apparatus to:

obtain a read image from a reader that reads a print-through image formed on a back surface opposite an image forming surface of a recording medium, wherein a target image is formed on the image forming surface with a color material, and the print-through image is formed on the back surface by the color material permeating through the recording medium;

obtain a comparison image in which the target image is at least recognizable;

compare the read image with the comparison image; and

depending on a result of the comparison, perform at least one of (i) control to adjust a printing process parameter and (ii) control to perform notification.

### BRIEF DESCRIPTION OF THE DRAWINGS

The advantages and features provided by one or more embodiments of the present disclosure will become more fully understood from the detailed description given hereinbelow and the appended drawings that are given by way of illustration only, and thus are not intended as a definition of the limits of the present invention, wherein:

FIG. 1 is a schematic view showing an overall configuration of an image forming apparatus according to an embodiment(s) of the present disclosure;

FIG. 2 is a block diagram showing a functional configuration of the image forming apparatus according to the embodiment;

FIG. 3 is a flowchart of an image inspection process that is performed by the image forming apparatus according to the embodiment;

FIG. 4A shows an example of a target image to be formed on a recording medium according to the embodiment;

FIG. 4B shows the target image reversed according to the embodiment;

FIG. 4C shows an example of a comparison image according to the embodiment;

FIG. 5 is a flowchart of a trial printing process in an image inspection process that is performed by the image forming apparatus according to a modification of the embodiment; and

FIG. 6 is a flowchart of a regular printing process in the image inspection process that is performed by the image forming apparatus according to the modification of the embodiment.

### DETAILED DESCRIPTION OF EMBODIMENTS

Hereinafter, one or more embodiments of the present disclosure will be described in detail with reference to the drawings. However, the scope of the present invention is not limited to the disclosed embodiments or illustrated examples.

[Configuration of Image Forming Apparatus]

Hereinafter, an embodiment(s) of the present disclosure will be described with reference to the drawings.

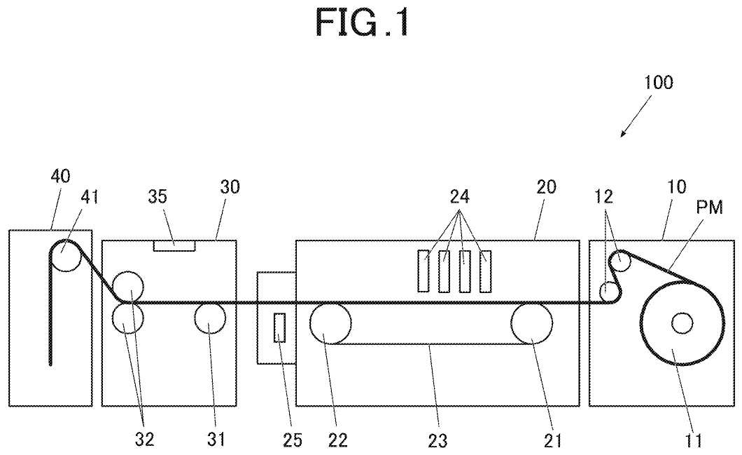

FIG. 1 is a front view to explain an outline of an overall configuration of an image forming apparatus 100 including an image processing apparatus 1000 according to an embodiment(s).

The image forming apparatus 100 includes a medium supplier 10, a recorder 20, a dryer 30 and a medium ejector 40;

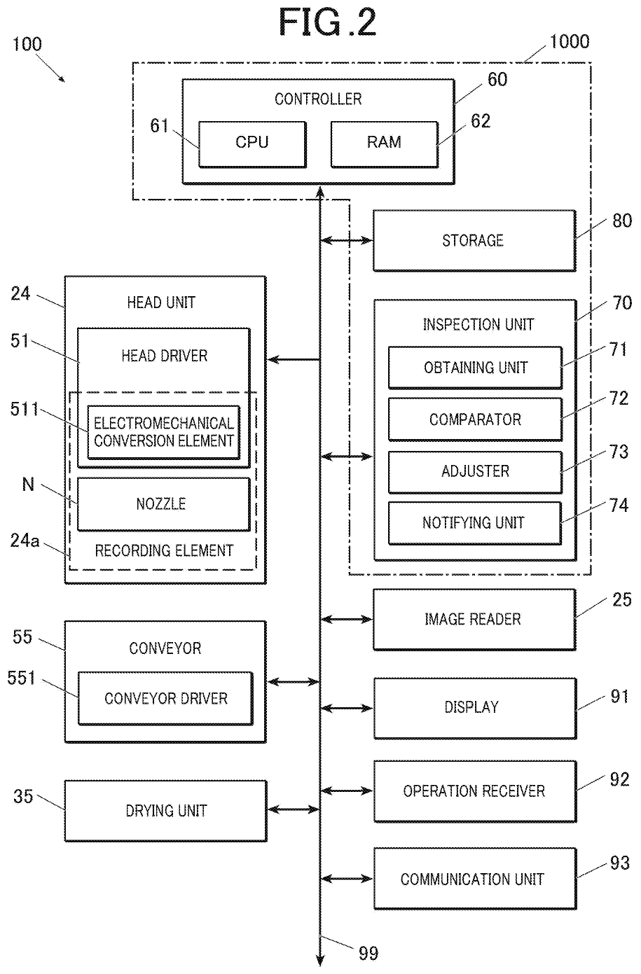

The medium supplier 10 includes a medium roller 11 and feeding rollers 12. Around the medium roller 11, a continuous recording medium PM, such as rolled paper or fabric, is wound. The medium roller 11 rotates at a speed corresponding to a conveying speed of a conveyor 55 (FIG. 2) to feed the recording medium PM toward a conveyance path of the conveyor 55. The feeding rollers 12 feed the recording medium PM to the conveyor 55 (recorder 20) while stretching the recording medium PM with proper tension. The recording medium PM is sent to the recorder 20 horizontally with creases, slack or the like stretched. The recording medium PM may not be a windable continuous medium. In such a case, stacked recording media PM may be fed and ejected one by one in order.

The recorder 20 includes a driving roller 21, a driven roller 22, a conveyor belt 23, head units 24 (image forming units) and an image reader 25 (reader).

The driving roller 21 rotates as a not-shown driving motor operates to circularly move the conveyor belt 23 at a predetermined speed. The conveyor belt 23 is an endless (ring-shaped) belt, and put across the driving roller 21 and the driven roller 22. The conveyor belt 23 circularly moves as the driving roller 21 rotates. Accordingly, the recording medium PM placed in a predetermined area on a conveyance surface, which is the outer circumferential surface of the conveyor belt 23, is conveyed so as to move in a predetermined direction (conveying direction) along the conveyance path. The driven roller 22 rotates as the conveyor belt 23 circularly moves.

Each head unit 24 has a line head in which recording elements 24a (FIG. 2) are disposed over a recordable width (the entire width or a width with predetermined margins left at both ends) of the recording medium PM in the width direction, which is perpendicular to (intersects with) the conveying direction in the plane of the recording medium PM placed on the conveyor belt 23. The head unit 24 ejects ink from each recording element 24a, thereby performing recording in a belt shape (linearly), and records an image (two-dimensional image) of a recording target on the recording medium PM in combination with conveyance of the recording medium PM. Two or more head units 24, four head units 24 in this embodiment, may be disposed in order at different positions (predetermined positions) in the conveying direction. These head units 24 may be set so as to eject ink of different colors (different types). For example, from the upstream side in the conveying direction, the head units 24 may eject ink of C (cyan), M (magenta), Y (yellow) and K (black), respectively, in order. The colors of the ink that is supplied to the head units 24 may be exchangeable or changeable, and also the ejection order may be changeable.

The image reader 25 reads, on the downstream side of the head units 24 in the conveying direction, the back surface opposite, of the recording medium PM, the surface (recording surface or image forming surface) on which an image is recorded by the head units 24. The image reader 25 includes, for example, a one-dimensional imaging sensor. In this embodiment, in the one-dimensional imaging sensor, imaging elements are arranged at least over the width of the conveyance path in the width direction. While the recording medium PM moves in the conveying direction, the image reader 25 can two-dimensionally image the back surface, which is opposite the recording surface of the recording medium PM. Examples of the imaging sensor include a CCD (Charge Coupled Device) sensor and a CMOS (Complementary Metal Oxide Semiconductor) sensor. These imaging sensors perform, with the imaging elements, imaging by outputting the amount of charges or a voltage corresponding to the amount of light that enters light receiving elements from the back surface, which is opposite the recording surface of the recording medium PM, via an optical system (lenses). In this embodiment, the imaging sensor can perform imaging at wavelength bands of R, G, B (multiple wavelength bands), and hence the image reader 25 can obtain color images.

The image reader 25 may include a not-shown illuminator. The illuminator irradiates an imaging surface substantially uniform, the imaging surface being imaged by the image reader 25. The image reader 25 may be disposed so as to perform imaging on the downstream side of a component(s) that performs post-processing related to image fixation, such as the dryer 30, in the conveying direction.

The dryer 30 dries and makes the ink on the recording medium PM adhere, thereby fixing the image, on the downstream side of the head units 24 (recorder 20) in the conveying direction. The dryer 30 includes conveying rollers 31, 32 and a drying unit 35.

The conveying rollers 31, 32 move, in the dryer 30, the recording medium PM sent from the recorder 20. The conveying rollers 32 are two conveying rollers that sandwich the recording medium PM after the ink is dried. The conveying rollers 32 generate force to pull the recording medium PM, thereby separating the recording medium PM placed on the conveyance belt 23 therefrom and bringing it into the dryer 30.

The drying unit 35 operates to dry and make the ink on the recording medium PM adhere. In this embodiment, the drying unit 35 performs heating and/or air blowing for evaporating moisture of water-based ink. Although not particularly limited, the dryer 30 has a housing, and the drying unit 35 is disposed in the housing. Thus, the dryer 30 has a structure that easily maintains heat generated by the drying unit 35. The inside air containing water vapor may be naturally released (which includes being flowed by wind caused by movement of the recording medium PM and/or the conveyor belt 23) from a gap of the housing or may be forcibly released by an exhaust fan or the like.

The medium ejector 40 includes an ejector roller 41, and drops the ink-dried-and-adhered recording medium PM sent from the dryer 30 onto a not-shown tray disposed at the bottom. The ejected recording medium PM may be sent to a post-processing apparatus or the like to be cut or the like as appropriate.

FIG. 2 is a block diagram showing a functional configuration of the image forming apparatus 100.

The image forming apparatus 100 includes the head units 24, the image reader 25, the drying unit 35, the conveyor 55, a controller 60, an inspection unit 70, a storage 80, a display 91, an operation receiver 92, a communication unit 93 and a bus 99.

Each head unit 24 further includes a head driver 51 in addition to the components described above. The head driver 51 includes electromechanical conversion elements 511. The electromechanical conversion elements 511 deform in accordance with an applied voltage, namely an output voltage of a drive signal, thereby deforming ink flow paths, in particular pressure chambers having a predetermined size and a predetermined shape for proper pressure fluctuation. The drive signal has a predetermined voltage waveform pattern, and whether to output the drive signal having the voltage waveform pattern to each electromechanical conversion element 511 corresponding to each nozzle N is determined according to a control signal and/or image data for driving (halftone image) from the controller 60. A proper amount of ink pushed out from the nozzles N by the deformation of/by the electromechanical conversion elements 511 (recording by the recording elements 24a) in accordance with the drive signal is separated from the ink in the ink flow paths and ejected as ink droplets. The electromechanical conversion elements 511 and the nozzles N are included in the recording elements 24a.

The conveyor 55 moves the recording medium PM in the abovementioned conveying direction (which may not be level/horizontal but change on the way) along the conveyance path, thereby moving relatively to the head units 24. The conveyor 55 includes a conveyor driver 551. The conveyor driver 551 operates components related to the conveyance of the recording medium PM. The components related to the conveyance include the medium roller 11 and the feeding rollers 12 of the medium supplier 10, the driving roller 21 and the driven roller 22 of the recorder 20, the conveying rollers 31, 32 of the dryer 30, the ejector roller 41 of the medium ejector 40, and rotary motors that rotate some or all of these. Driving timings and driving speeds of the rotary motors are synchronized, and may be appropriately adjusted in part according to a condition, such as tension applied to the recording medium PM. The structure to convey the recording medium PM is not limited to the one in which an endless belt is circularly moved by rollers, and hence, for example, may be the one in which the recording medium PM is moved directly by rollers or the one in which the recording medium PM is moved along the surface of a cylindrical rotary drum that is larger than a roller.

The controller 60 is a hardware processor that controls overall operation of the image forming apparatus 100. The controller 60 includes a CPU (Central Processing Unit) 61 and a RAM (Random Access Memory) 62.

The controller 60 performs various control processes related to image recording based on, for example, image data and a status signal and a clock signal of each component. The controller 60 also performs processes of, for example, performing operation adjustment related to, for example, ink ejection from the nozzles N, detecting a failure state of ink ejection and coping with the failure, and detecting decrease in image quality and adjusting the image quality. Processes on image data include a process of converting the original image data of the recording target into halftone image data defining whether to eject ink in units of the electromechanical conversion elements 511 (a process of generating image data of an image to be recorded). The halftone image is two-dimensional data in which a plurality of line data (raster data) are arranged. Each line data indicates ink ejection/landing by the recording elements 24a to positions (ink landing positions) in the width direction about a position in the conveying direction. Intervals between lines in an image to be recorded are determined by the conveying speed of the recording medium PM and the ejection frequency of the ink.

Further, the controller 60 obtains a read image read by the image reader 25.

Still further, the controller 60 reverses a target image received via the communication unit 93 to be formed on the recording medium PM, and multiplies the reversed target image by a print-through ratio received via the operation receiver 92, thereby generating a comparison image. The comparison image is an image desired by a user to be formed on the back surface of the recording medium PM, wherein, of the recording medium PM, a surface on which an image is formed by the head units 24 is the front surface.

In this embodiment, the comparison image is an image in which the target image formed on the front surface is at least recognizable from the back surface, and is an image that is formed when print-through is deliberately caused.

The CPU 61 performs various types of arithmetic processing and controls, for example, conveyance of the recording medium PM, ink supply, ink ejection, and reading of the back surface of the recording medium PM in the image forming apparatus 100. The CPU 61 also performs various types of arithmetic processing and control related to various processes in accordance with programs read from the storage 80.

The RAM 62 provides a working memory space for the CPU 61 and stores temporary data. The RAM 62 and a DRAM region of the storage 80 may each take partial charge of a region where temporary data is stored, as appropriate.

As shown in FIG. 2, the inspection unit 70 includes an obtaining unit 71, a comparator 72, an adjuster 73 and a notifying unit 74.

Process details of the components of the inspection unit 70 can be performed by hardware processing using an image processing circuit(s), such as an ASIC (Application Specific Integrated Circuit) or an FPGA (Field-Programmable Gate Array), or by software processing by a processor, such as a CPU or a GPU (Graphics Processing Unit), reading a program(s).

The obtaining unit 71 obtains a comparison image stored in the storage 80, when an image inspection process described below is performed. Alternatively, the obtaining unit 71 may obtain a comparison image stored outside via the communication unit 93, when the image inspection process is performed.

The comparator 72 compares, in units of pixels, a read image with the comparison image obtained by the obtaining unit 71. Because the print-through ratio changes according to ink, a recording medium, a coverage rate and so forth used for image formation, the comparison in units of pixels is preferable.

From the comparison result of the read image with the comparison image, the comparator 72 determines whether the image quality of the read image is within an allowable range based on the comparison image.

The adjuster 73 adjusts a printing process parameter if the comparator 72 determines from the comparison result that the image quality of the read image is not within the allowable range based on the comparison image.

Examples of the printing process parameter include the voltage waveform pattern of the drive signal in order to change the ejection amount of ink.

The notifying unit 74 causes the display 91 to display a message if the comparator 72 determines from the comparison result that the image quality of the read image is not within the allowable range based on the comparison image, the message that the image quality of the read image is not within the allowable range.

The controller 60 controls (causes) one or both of (i) the adjuster 73 to perform the adjustment and (ii) the notifying unit 74 to perform the notification.

The storage 80 stores programs, various setting data, job data related to image recording commands, and so forth.

In this embodiment, the storage 80 includes a volatile memory, such as a DRAM (Dynamic Random Access Memory), and a nonvolatile memory.

The display 91 displays the status of the image forming apparatus 100, an operation menu and so forth on its display screen in response to control signals from the controller 60. The display screen is a liquid crystal screen, for example. The display 91 may include an LED lamp(s) that indicates supply or no-supply of power and/or gives warning of an error(s).

The display 91 also displays messages for a user in accordance with instructions from the notifying unit 74.

The operation receiver 92 receives and outputs user operations to the controller 60. The operation receiver 92 includes a touch sensor or the like. The touch sensor may be superposed on the display screen of the display 91 and used as a touchscreen. The operation receiver 92 outputs information on the position and type of a touch operation detected by the touch sensor to the controller 60. The operation receiver 92 may include a push-button switch and/or a numeric keypad.

The operation receiver 92 receives the print-through ratio specified therewith and outputs information thereon to the controller 60. The print-through ratio is the ratio of print-through image density on the back surface of the recording medium PM to image density on the surface (front surface) of the recording medium PM, the surface on which an image is formed.

The communication unit 93 is a communication interface that controls communications with an external device(s). The communication interface includes, for example, one or more network cards for various communication protocols, such as a LAN card. Under the control of the controller 60, the communication unit 93 can obtain job data including image data of the recording target and settings related to image recording from an external device(s), and also transmit the status information and so forth to an external device(s).

The bus 99 is a path that electrically connects the controller 60 and components that exchange signals with the controller 60 to transmit the signals.

A computer of this embodiment includes, among the components described above, at least the controller 60, and may further include the storage 80, the display 91, the operation receiver 92, the communication unit 93, the bus 99 and/or the like.

The controller 60, the inspection unit 70 and the storage 80 function as (constitute) the image processing apparatus 1000.

When comparison images are stored outside and obtained via the communication unit 93, the controller 60 and the inspection unit 70 function as (constitute) the image processing apparatus 1000.

(Operation of Image Forming Apparatus 100)

Next, operation of this embodiment will be described.

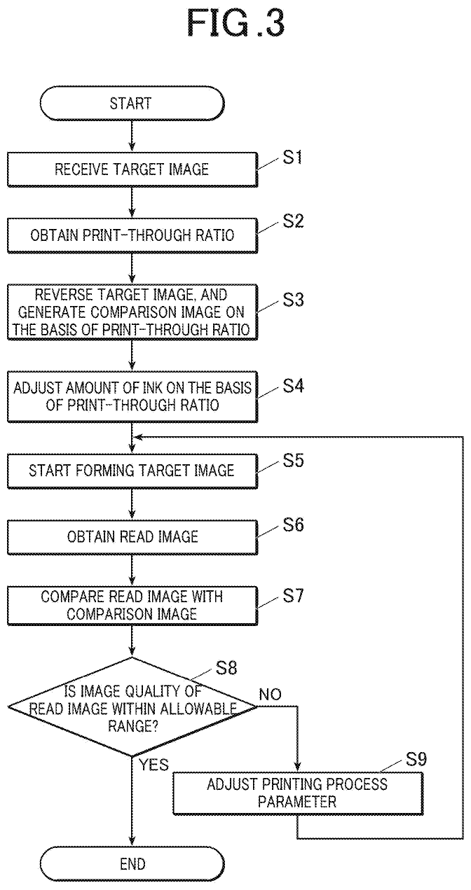

FIG. 3 is a flowchart of the image inspection process that is performed in the image forming apparatus 100. The image inspection process is performed by the controller 60 and a program(s) stored in the storage 80 in cooperation with one another.

First, the controller 60 receives, via the communication unit 93, a target image to be formed on a recording medium PM (Step S1).

Next, the controller 60 obtains a user's desired print-through ratio via the operation receiver 92 (Step S2).

Next, the controller 60 reverses the received target image, and generates a comparison image by multiplying the density of the reversed target image by the print-through ratio in units of pixels (Step S3), and causes the storage 80 to store the comparison image.

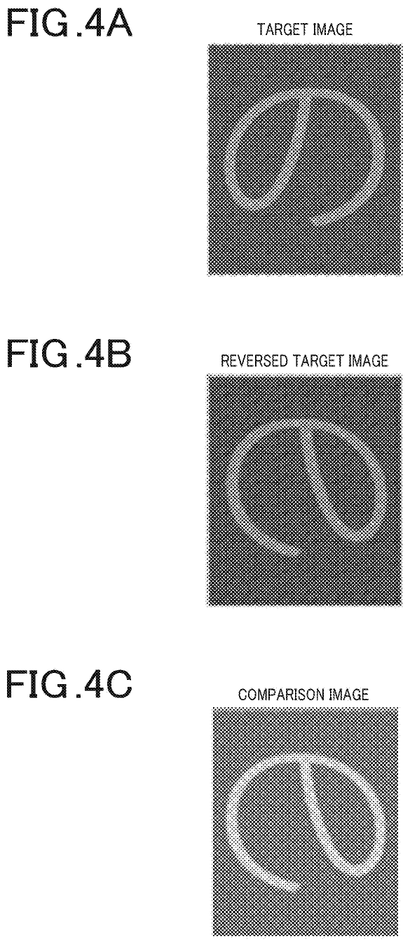

FIG. 4A shows an example of the target image, FIG. 4B shows an example of the reversed target image, and FIG. 4C shows an example of the comparison image.

Next, the controller 60 adjusts, on the basis of the print-through ratio, the amount of ink to be used for image formation (Step S4).

Next, the controller 60 controls the head units 24 to start forming the target image (Step S5).

Next, the controller 60 controls the image reader 25 to read the surface (back surface), which is opposite the image forming surface of the recording medium PM, having the image formed by the head units 24, and obtains the read image (Step S6).

The obtaining unit 71 obtains the comparison image from the storage 80, and the comparator 72 compares the read image obtained by the controller 60 with the comparison image in units of pixels (Step S7).

Next, the comparator 72 determines from the comparison result of the read image with the comparison image whether the image quality of the read image is within an allowable range based on the comparison image (Step S8).

If the image quality of the read image is within the allowable range (Step S8; YES), the controller 60 ends the process.

If the image quality of the read image is not within the allowable range (Step S8; NO), the controller 60 controls the adjuster 73 to adjust the printing process parameter (Step S9), and returns to Step S5.

In Step S9, the controller 60 may control the notifying unit 74 to cause the display 91 to display a message that the image quality of the read image is not within the allowable range.

As described above, the image processing apparatus 1000 includes: a hardware processor (controller 60) that obtains a read image from a reader (image reader 25) that reads a print-through image formed on the back surface opposite the image forming surface of a recording medium, wherein a target image is formed on the image forming surface with a color material, and the print-through image is formed on the back surface by the color material permeating through the recording medium; an obtaining unit (obtaining unit 71) that obtains a comparison image in which the target image is at least recognizable; a comparator (comparator 72) that compares the read image with the comparison image; an adjuster (adjuster 73) that adjusts a printing process parameter; and a notifying unit (notifying unit 74) that performs notification, wherein depending on a result of the comparison by the comparator, the hardware processor (controller 60) causes at least one of (i) the adjuster to perform the adjustment and (ii) the notifying unit to perform the notification.

Thus, there can be provided an image processing apparatus, an image forming apparatus and a computer readable storage medium storing a program each of which is capable of performing image formation with a user's desired print-through image density.

(Modification)

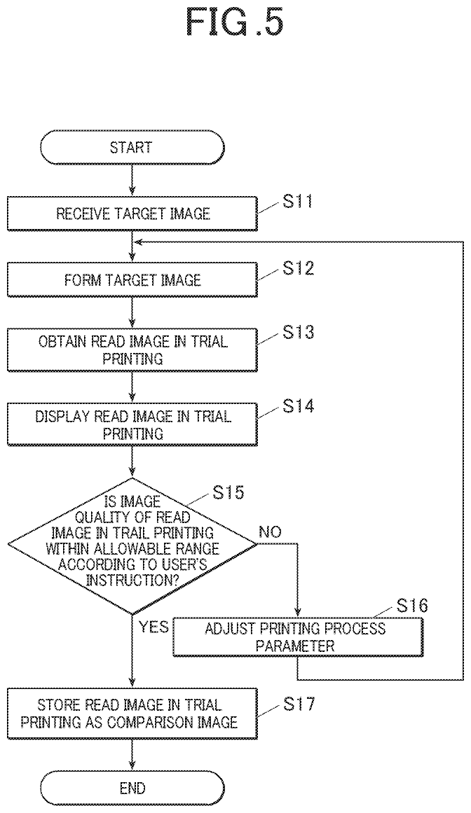

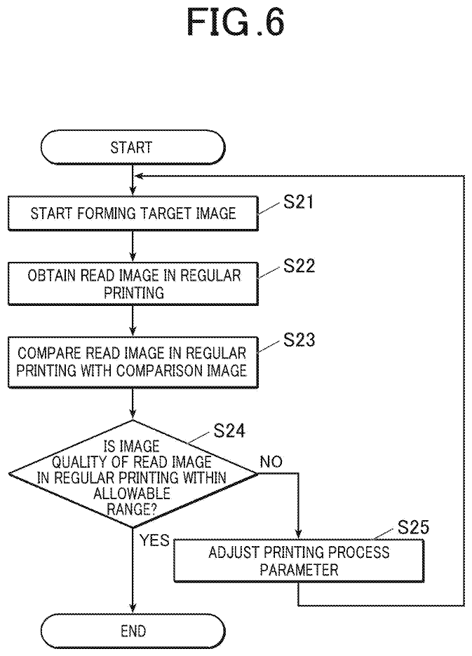

FIG. 5 is a flowchart of a trial printing process in an image inspection process according to a modification. FIG. 6 is a flowchart of a regular printing process in the image inspection process according to the modification. Hereinafter, differences from the above embodiment will be described mainly. The image forming apparatus 100 of this modification is the same as the image forming apparatus 100 of the above embodiment in configuration.

In the trial printing process in the image inspection process of this modification shown in FIG. 5, first, the controller 60 receives, via the communication unit 93, a target image to be formed on a recording medium PM (Step S11).

Next, the controller 60 controls the head units 24 to form the target image on the recording medium PM (Step S12).

Next, the controller 60 controls the image reader 25 to read the surface (back surface), which is opposite the image forming surface of the recording medium PM, having the image formed by the head units 24, and obtains the read image in trial printing (Step S13).

Next, the controller 60 causes the display 91 to display the read image in trial printing (Step S14).

A user checks the displayed read image in trial printing, and determines whether the image quality of the read image in trial printing is within an allowable range based on his/her desired image (Step S15).

If the image quality of the read image in trial printing is within the allowable range (Step S15; YES), the controller 60 receives, via the operation receiver 92, a user operation to store the read image in trial printing as a comparison image, and causes the storage 80 to store the read image in trial printing as a comparison image (Step S17), and ends the process.

If the image quality of the read image in trial printing is not within the allowable range (Step S15; NO), the controller 60 controls the adjuster 73 to adjust the printing process parameter (Step S16), and returns to Step S12.

When the trial printing process in the image inspection process of this modification shown in FIG. 5 ends, the regular printing process in the image inspection process of this modification shown in FIG. 6 is performed.

First, the controller 60 controls the head units 24 to start forming the target image (Step S21).

Next, the controller 60 controls the image reader 25 to read the surface (back surface), which is opposite the image forming surface of the recording medium PM, having the image formed by the head units 24, and obtains the read image in regular printing (Step S22).

The obtaining unit 71 obtains the comparison image from the storage 80, the comparison image being stored in the trial printing process, and the comparator 72 compares the read image in regular printing obtained by the controller 60 with the comparison image in units of pixels (Step S23).

Next, the comparator 72 determines from the comparison result of the read image in regular printing with the comparison image whether the image quality of the read image in regular printing is within an allowable range based on the comparison image (Step S24).

If the image quality of the read image in regular printing is within the allowable range (Step S24; YES), the controller 60 ends the process.

If the image quality of the read image in regular printing is not within the allowable range (Step S24; NO), the controller 60 controls the adjuster 73 to adjust the printing process parameter (Step S25), and returns to Step S21.

In Step S25, the controller 60 may control the notifying unit 74 to cause the display 91 to display a message that the image quality of the read image in regular printing is not within the allowable range.

As described above, when a user does not set a print-through ratio, the obtaining unit 71 obtains a trial read image read in trial printing (read image in trial printing) as a comparison image.

Thus, there can be provided an image processing apparatus, an image forming apparatus and a computer readable storage medium storing a program each of which is capable of performing image formation with a user's desired print-though image density.

The above embodiment and modification are merely some of preferred examples of the image forming apparatus according to the present disclosure and not intended to limit the present invention.

For example, in the above embodiment and modification, the controller 60, the inspection unit 70 and the storage 80 function as (constitute) the image processing apparatus 1000, or the controller 60 and the inspection unit 70 function as (constitute) the image processing apparatus 1000, but these are not intended to limit the present invention. For example, the above components and the image reader 25 may function as (constitute) the image processing apparatus 1000.

Further, in the above embodiment and modification, the image processing apparatus 1000 is disposed in the image forming apparatus 100, but this is not intended to limit the present invention. The image processing apparatus may be a separate apparatus from an image forming apparatus that includes the head units 24.

Still further, in the above embodiment and modification, the image forming apparatus 100 is an inkjet printer, but this is not intended to limit the present invention. The image forming apparatus 100 may be an electrophotographic printer.

The detailed configuration and operation of each component of the image forming apparatus can also be appropriately modified within a range not departing from the scope of the present invention.

Although one or more embodiments or the like of the present disclosure have been described and illustrated in detail, the disclosed embodiments or the like are made for purposes of not limitation but illustration and example only. The scope of the present invention should be interpreted by terms of the appended claims.

What is claimed is:

1. An image processing apparatus comprising:
a hardware processor that obtains a read image from a reader that reads a print-through image formed on a back surface opposite an image forming surface of a recording medium, wherein a target image is formed on the image forming surface with a color material, and the print-through image is formed on the back surface by the color material permeating through the recording medium;
an obtaining unit that obtains a comparison image in which the target image is at least recognizable;
a comparator that compares the read image with the comparison image;
an adjuster that adjusts a printing process parameter; and
a notifying unit that performs notification,
wherein depending on a result of the comparison by the comparator, the hardware processor causes at least one of (i) the adjuster to perform the adjustment and (ii) the notifying unit to perform the notification.

2. The image processing apparatus according to claim 1, wherein the hardware processor generates the comparison image based on the target image and a print-through ratio for the print-through image.

3. The image processing apparatus according to claim 2, wherein the hardware processor reverses the target image and multiplies a density of the reversed target image by the print-through ratio in units of pixels, thereby generating the comparison image.

4. The image processing apparatus according to claim 2, further comprising an operation receiver,
wherein the hardware processor sets the print-through ratio specified by a user operation received by the operation receiver.

5. The image processing apparatus according to claim 1, wherein the obtaining unit obtains a trial read image read by the reader in trial printing as the comparison image.

6. The image processing apparatus according to claim 1, wherein the comparator compares the read image with the comparison image in units of pixels.

7. The image processing apparatus according to claim 1, wherein the notifying unit notifies an image quality of the read image, thereby performing the notification.

8. The image processing apparatus according to claim 1, further comprising the reader.

9. An image forming apparatus comprising:
an image forming unit that forms an image on a recording medium; and
the image processing apparatus according to claim 1.

10. A non-transitory computer readable storage medium storing a program that causes a computer of an image processing apparatus to:
obtain a read image from a reader that reads a print-through image formed on a back surface opposite an image forming surface of a recording medium, wherein a target image is formed on the image forming surface with a color material, and the print-through image is formed on the back surface by the color material permeating through the recording medium;
obtain a comparison image in which the target image is at least recognizable;
compare the read image with the comparison image; and
depending on a result of the comparison, perform at least one of (i) control to adjust a printing process parameter and (ii) control to perform notification.
